(19) United States
(12) Patent Application Publication
(10) Pub. No.: US 2004/0071427 A1
(43) Pub. Date: Apr. 15, 2004

(54) Waveguide-grating-based wavelength-intelligent devices

(75) Inventors: Peiching Ling, San Jose, CA (US); Jianjun Zhang, Cupertino, CA (US); Jianliang Chen, Saratoga, CA (US); Ming Xu, San Jose, CA (US)

Correspondence Address: Bo-Lin, 13445 Mandoll Drive, Los Altos, CA, 94022, US

(73) Assignee: Integrated Optics Communication Corp.

(21) Appl. No.: 10/683,740

(22) Filed: Oct. 9, 2003

Related U.S. Application Data
(60) Provisional application No. 60/417,148, filed on Oct. 9, 2002.

(51) Int. Cl. G02B 6/10

(52) U.S. Cl. 385/131

(57) ABSTRACT

Electrically activated, wavelength-selective optical switches, a tunable wavelength selector, and a wavelength-tunable light modulator. In one preferred embodiment, an electrically activated, wavelength-selective optical switch comprises on a common substrate a first waveguide, a second waveguide comprising an electro-optic material, a set of Bragg gratings, and a means for generating an electrical field across the second waveguide. When the electrical field is applied, the refractive index of the electro-optic material and the Bragg phase-matching condition of the Bragg gratings are changed, causing one of the multiplexed input optical signals in the first waveguide to be guided by mode coupling into the second waveguide.

This application claims priority to a pending U.S. provisional patent application entitled WAVEGUIDE GRATING-BASED WAVELENGTH-INTELLIGENT DEVICE, filed Oct. 9, 2002 by Ling et al. and accorded a Serial No. 60/417,148, the benefit of its filing date being hereby claimed under Title 35 of the United States Code. The Patent Application 60/417,148 is a Continuation in Part (CIP) Application and claims priority to pending U.S. provisional patent application entitled WAVEGUIDE GRATING-BASED WAVELENGTH SELECTIVE SWITCH ACTUATED BY MICRO-ELECTROMECHANICAL SYSTEM filed Oct. 22, 2001 by Zhang et al. and accorded a Serial No. 60/348,927, the benefit of its filing date being hereby claimed under Title 35 of the United States Code.

### BACKGROUND OF THE INVENTION

1. Field of the Invention

This invention relates generally to wavelength-intelligent optic devices based on waveguides with Bragg gratings, and in particular to waveguide-grating-based, wavelength-intelligent optic devices having electrically tunable elements comprising electro-optic materials.

2. Description of the Related Art

All-optical-fiber networks are increasingly being used as the backbone for global communication systems because of the extremely broad transmission bandwidth provided by optical fiber. Conventional optical switching and signal transmission systems involve optical switching of an entire spectral range without wavelength differentiation or selection. As such, even though optical switches taught in the prior art provide the advantage of switching optical signals entirely in the optical domain without converting the signals to the electrical domain, the operation of such optical switches typically requires a wavelength de-multiplexing device and a wavelength re-multiplexing device to achieve the purpose of transmitting optical signals of different wavelengths to different ports. This requirement results in complex system configurations, higher manufacture and maintenance costs, and lower system reliability.

To fully exploit the broad bandwidth in all-optical-fiber networks, technologies such as wavelength-division multiplexing (WDM), wavelength-division demultiplexing (WDD) and dense wavelength-division multiplexing (DWDM) have been developed, such that several independent optical streams, each distinguished from the other by its center wavelength, can be transmitted simultaneously through a single optical fiber. Since these optical streams are coupled and decoupled based on their wavelengths, wavelength-differentiable, wavelength-selective and even wavelength-tunable devices are essential to WDM and DWDM communication networks. Such “wavelength-intelligent” devices not only must perform adding, dropping and cross-connecting of individual wavelengths in the optical domain with high spectral selectivity, low insertion loss and low polarization sensitivity, but also must be easy and inexpensive to make.

Three types of wavelength-selective devices are used in today's all-optical DWDM networks: Thin Film Filters (TFF), Arrayed Waveguides (AWG) and Fiber Bragg Gratings (FBG). The TFF technology is currently the predominant choice when the spacing requirements of the wavelength-selective device are greater than 100 GHz, while AWG and FBG wavelength-selective devices dominate the market when the spacing requirements are 100 GHz and below. In addition, advanced optical switching devices based on several other technologies, including micro electro-mechanical systems (MEMS), liquid crystals, thermal optics and holograms, are also being developed.

Among these advanced optical switching technologies, MEMS appears to be the most promising technology because of its potential for batch processing and low-cost replication as well as its sound record of reliability in a wide range of applications. However, most MEMS-based switches taught in the prior art are not “wavelength-intelligent” in the sense that they still require the use of external de-multiplexing and re-multiplexing to transmit optical signals of different wavelengths to different ports.

Bragg gratings have recently been used to add wavelength intelligence to conventional as well as MEMS-based optical switches. A set of Bragg gratings behaves as a wavelength-selective filter, reflecting a narrow band of wavelengths while transmitting all other wavelengths. In the co-pending patent application entitled, “Waveguide Grating-Based Wavelength Selective Switch Actuated by Micro-Electromechanical System,” Ser. No. 10/177,632, filed on Jun. 19, 2002, a MEMS-actuated, waveguide-grating-based wavelength-selective switch is described. As shown in FIG. 1, a schematic representation of one of the preferred embodiments of that application, an innovative optical switch 10 comprises a first waveguide 12, e.g., a multi-channel bus waveguide; a second, wavelength-selective waveguide 14 having thereon a set of Bragg gratings 16; and a MEMS (not shown). In the “OFF” position, multiplexed optical signals of wavelengths λ₁, λ₂, . . . , λᵢ, . . . , λ_{N-1} and λ_{N} are transmitted over the first waveguide 12. In the “ON” position, the second waveguide 14 is moved sufficiently close to the first waveguide 12 by the MEMS, such that the optical signal having a center wavelength λᵢ that meets the Bragg phase-matching condition is guided by mode coupling into the second waveguide 14, while the remaining optical signals λ₁, λ₂, . . . , λᵢ₋₁, λᵢ₊₁, . . . , λ_{N-1} and λ_{N} continue to be transmitted over the first waveguide 12. This co-pending patent application is incorporated herein by reference in its entirety.

Another wavelength-selective optical device based on mode coupling is taught in U.S. Pat. No. 5,859,941, entitled “Optical Add/Drop Multiplexer Device” and issued to M. Horita et al. on Jan. 12, 1999, wherein the optical add/drop multiplexer capable of extracting or inserting optical signals of a specific wavelength comprises two waveguides formed over the same substrate, each waveguide having a portion arranged in parallel and in proximity to the other waveguide to form a coupling section. A diffraction grating having a prescribed period along the light propagation direction is provided at the coupling section for reflecting light signals with a specific wavelength from one of the waveguides to the other waveguide. In addition, an electrode structure may be provided on one or both sides of the waveguides for applying heat, a current or an electrical field to the coupling section to change the specific wavelength of the light signals to be reflected by the diffraction grating. U.S. Pat. No. 5,859,941 is incorporated herein by reference.

U.S. Pat. No. 6,353,690 B1, entitled “Electrically Adjustable Diffraction Grating” and issued to M. Kulishov on Mar. 5, 2002, teaches another electrically adjustable, wavelength-selective device, i.e., a diffraction grating, wherein both the refractive index and the spatial periodicity of the grating may be electrically adjusted by using electrode structures disposed in parallel to the light propagation direction. U.S. Pat. No. 6,353,690 B1 is incorporated herein by reference.

Although each of the aforesaid co-pending application and related art references teaches one or more wavelength-selective optical devices, constant advances made in other aspects of the all-optical broad-band networking technology dictates that additional wavelength-intelligent optical devices be made to eliminate unbalanced power loss, to further reduce the insertion loss and power consumption, to simplify fabrication and packaging processes, and to further improve the reliability of such optical devices.

### SUMMARY OF THE INVENTION

Accordingly, it is an object of the present invention to provide wavelength-intelligent optical devices that are wavelength-selective and wavelength-tunable.

It is another object of the present invention to provide wavelength-intelligent optical devices that, compared to conventional optical devices, have reduced unbalanced power loss, insertion loss and power consumption.

It is a further object of the present invention to provide wavelength-intelligent optical devices that are simple in structure and easy for fabrication and packaging.

Briefly, in accordance with the objects described above, the present invention provides in one of the preferred embodiments an electrically activated wavelength-selective optical switch, comprising on a common substrate a first waveguide, e.g., a bus waveguide; a second waveguide comprising an electro-optic material; and a set of Bragg gratings. The switch further comprises a means for generating an electrical field, e.g., two parallel electrodes connected to a voltage source and located either on or off the substrate. In the absence of the electrical field, multiplexed optical signals of wavelengths λ₁, λ₂, . . . ,λᵢ, . . . , λ_{N-1} and λ_{N} are transmitted over the first waveguide. When the electrical field is applied across the second waveguide or the entire substrate, the refractive index of the electro-optic material is changed and, accordingly, the Bragg phase-matching condition of the gratings is altered. One of the optical signals has a center wavelength λᵢ that meets the new Bragg phase-matching condition, and as a result it will be guided by mode coupling into the second waveguide, while the remaining optical signals λ₁, λ₂, . . . , λᵢ₋₁, λᵢ₊₁, . . . , λ_{N-1} and λ_{N} will continue to be transmitted over the first waveguide.

In another preferred embodiments, the present invention provides a wavelength-selective, wavelength-tunable optical switch, comprising on a common substrate a first waveguide, e.g., a bus waveguide; a second waveguide comprising an electro-optic material; and a set of Bragg gratings. The switch further comprises a means for generating an electrical field, e.g., two parallel electrodes connected to a voltage source and located either on or off the substrate. In the absence of the electrical field, among the multiplexed input optical signals of wavelengths λ₁, λ₂, . . . , λᵢ, . . . , and λ_{N} that are transmitted over the first waveguide, one of the optical signals has a center wavelength λᵢ, that meets the Bragg phase-matching condition and is guided by mode coupling into the second waveguide, while the other optical signals λ₁, λ₂, . . . , λᵢ₋₁, λᵢ₊₁, . . . , and λ_{N} are transmitted over the first waveguide. When the electrical field is applied across the second waveguide or the entire substrate, the refractive index of the electro-optic material is changed and, accordingly, the Bragg phase-matching condition of the gratings is altered, such that the wavelength λᵢ no longer meets the Bragg phase-matching condition. As a result, either: (i) the switch is “turned off,” with all of the original input optical signals of wavelengths λ₁, λ₂, . . . , λᵢ, . . . , and λ_{N} being transmitted over the first waveguide; or (ii) the switch is “tuned” to another optical signal of a center wavelength λⱼ that meets the new Bragg phase-matching condition, such that this second optical signal λⱼ will be guided by mode coupling into the second waveguide, while the remaining optical signals λ₁, λ₂, . . . , λᵢ, . . . , λⱼ₋₁, λⱼ₊₁, . . . , and λ_{N} will be transmitted over the first waveguide.

According to still another preferred embodiment of the present invention, a wavelength-selective optical switch comprises a first waveguide; a second waveguide intersecting, juxtaposed or crossed over with the first waveguide; a third waveguide (i.e., the bridge waveguide) comprising an electro-optic material; two sets of Bragg gratings disposed on the bridge waveguide having two different Bragg phase-matching conditions; and a means for generating an electrical field, e.g., two electrodes placed across the first set of Bragg gratings. In the absence of the electrical field, multiplexed input optical signals of wavelengths λ₁, λ₂, . . . , λᵢ, . . . , and λ_{N} are transmitted over the first waveguide. When the electrical field is applied, the refractive index of the electro-optical material is changed, causing the Bragg phase-matching condition of the first set of Bragg gratings to be identical to that of the second set of Bragg gratings. As a result, one of the optical signals having a center wavelength λᵢ is selectively guided into the bridge waveguide via mode coupling, travels along the bridge waveguide until it is coupled through the second set of Bragg gratings into the second waveguide, and is further transmitted over the second waveguide, while the remaining optical signals λ₁, λ₂, . . . ,λᵢ₋₁, λᵢ₊₁, . . . , and λ_{N} continue to be transmitted over the first waveguide.

According to yet another preferred embodiment of the present invention, a wavelength-intelligent optical switch comprises a first waveguide; a second waveguide intersecting, juxtaposed or crossed over with the first waveguide; a third waveguide (i.e., the bridge waveguide) comprising an electro-optic material; two identical sets of Bragg gratings disposed on the bridge waveguide; and a means for generating an electrical field at each set of the Bragg gratings, e.g., two electrodes placed across the Bragg gratings. In the absence of the electrical field, among the multiplexed input optical signals of wavelengths λ₁, λ₂, . . . , λᵢ, . . . , and λ_{N} that are transmitted over the first waveguide, one of the signals has a center wavelength λᵢ that meets the Bragg phase-matching condition of the two sets of Bragg gratings, and is guided by mode coupling through the bridge waveguide into the second waveguide, while the remaining optical signals λ₁, λ₂, . . . , λᵢ₋₁, λᵢ₊₁, . . . , and λ_{N} continue to be transmitted over the first waveguide. When the electrical field is applied to both sets of Bragg gratings, the refractive index of the electro-optical material is changed and, accordingly, the Bragg phase-matching condition at both sets of the Bragg gratings is altered, causing another one of the optical signals having a center wavelength λⱼ, instead of the signal of wavelengthλᵢ, to be selectively guided into the bridge waveguide via mode coupling. This optical signal of wavelength λⱼ travels along the bridge waveguide until it is coupled into the second waveguide and further transmitted over the second waveguide, while the remaining optical signals λ₁, λ₂, . . . , λᵢ, . . . , λⱼ₋₁, λⱼ₊₁, . . . , and λ_{N} are transmitted over the first waveguide. Depending on the magnitude of the electrical field, the optical signal guided into the bridge waveguide can be selectively changed from λᵢ to λⱼ or a number of other wavelengths, thus making this switch wavelength-tunable.

According to another preferred embodiment of the present invention, a wavelength-selective optical switch comprises a first waveguide comprising an electro-optic material; a second waveguide intersecting, juxtaposed or crossed over with the first waveguide; a third waveguide (i.e., the bridge waveguide) comprising the same electro-optic material as that of the first waveguide; the second waveguide having a set of Bragg gratings disposed thereon near one end of the bridge waveguide; and a means for generating an electrical field, e.g., two electrodes located near the other end of the bridge waveguide and the adjacent section of the first waveguide. In the absence of an electrical field, the input optical signal having a center wavelength λᵢ is directly coupled from the first waveguide to the bridge waveguide. This optical signal λᵢ is subsequently guided into the second waveguide via mode coupling at the Bragg gratings. When the electrical field is applied to the first waveguide and bridge waveguide, the two waveguides experience an applied field in opposite directions and hence experience opposite changes in their refractive indices, resulting in a phase mismatch between these two waveguides. By properly adjusting the magnitude of the electric field, the transmission of light power from the first waveguide to the bridge waveguide can be “switched off,” causing the input optical signal λᵢ to continue to be transmitted over the first waveguide.

According to still another preferred embodiment of the present invention, a tunable wavelength selector comprises a first waveguide, a second waveguide comprising an electro-optic material; a set of Bragg gratings disposed on the second waveguide; and a means for generating an electric field across the Bragg gratings. In the absence of the electric field, multi-channeled input optical signals of wavelengths λ₁, λ₂, . . . , λᵢ, . . . , and λ_{N} are transmitted over the first waveguide. When the electric field is applied, the refractive index of the electro-optical material and the Bragg phase-matching condition of the Bragg gratings are changed, such that one of the input optical signals having a center wavelength λᵢ may be selectively guided into the second waveguide via mode coupling. Depending on the magnitude of the electric field, the optical signal guided into the second waveguide can be selectively switched from one channel λᵢ to another channel λⱼ. This tunable wavelength selector can also be used to fine-tune the wavelength within a channel, e.g., from λᵢ to λᵢ+Δλᵢ.

According to yet another preferred embodiment of the present invention, a wavelength-tunable light modulator comprises a first waveguide; a second waveguide in parallel to, intersecting or crossed over with the first waveguide; a bridge waveguide comprising an electro-optical material; two identical sets of Bragg gratings disposed on the bridge waveguide; a means for generating an electrical field at each set of the Bragg gratings; and a broadband light source. In the absence of an electric field, all of the multiplexed input optical signals of wavelengths λ₁, λ₂, . . . , λᵢ, . . . , and λ_{N} from the broadband light source are transmitted over the first waveguide. When an electric field is applied, the refractive index of the electro-optical material of the bridge waveguide and the Bragg phase-matching conditions of the Bragg gratings are changed, causing one of the optical signals having a center wavelength λᵢ to be selectively guided into the bridge waveguide via mode coupling and subsequently to be “filtered” and coupled to the second waveguide. Depending on the magnitude of the electrical field, the optical signal guided into the bridge waveguide can be selectively switched from one wavelength λᵢ to another wavelength λⱼ. This optical output signal may in addition be modulated by an information-bearing signal.

An advantage of the present invention is that it provides several optical devices suitable for all-optical broadband applications.

Another advantage of the present invention is that the optical devices herein disclosed require simplified fabrication and packaging processes, lower costs and improved reliability.

These and other objects, features and advantages of the present invention will no doubt become apparent to those skilled in the art after reading the following detailed description of the preferred embodiments that are illustrated in the several accompanying drawings.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1 is a schematic representation of a prior-art, MEMS-actuated wavelength-selective optical switch.

FIGS. 2A, 2B, 2C and 2D are schematic representations of an electrically activated wavelength-sensitive optical switch of the present invention.

FIGS. 3A, 3B, 3C, 3D, 3E and 3F are schematic representations of a wavelength-selective, wavelength-tunable optical switch of the present invention.

FIG. 4 is a schematic representation of a wavelength-selective optical switch of the present invention.

FIG. 5 is a schematic representation of a wavelength-intelligent optical switch of the present invention.

FIG. 6 is a schematic representation of a wavelength-selective optical switch of the present invention.

FIG. 7 is a schematic representation of an electrode structure of the present invention for applying an electrical field across an electro-optic material.

FIG. 8 is a schematic representation of a tunable wavelength selector of the present invention.

FIG. 9 is a schematic representation of a wavelength-tunable light modulator of the present invention.

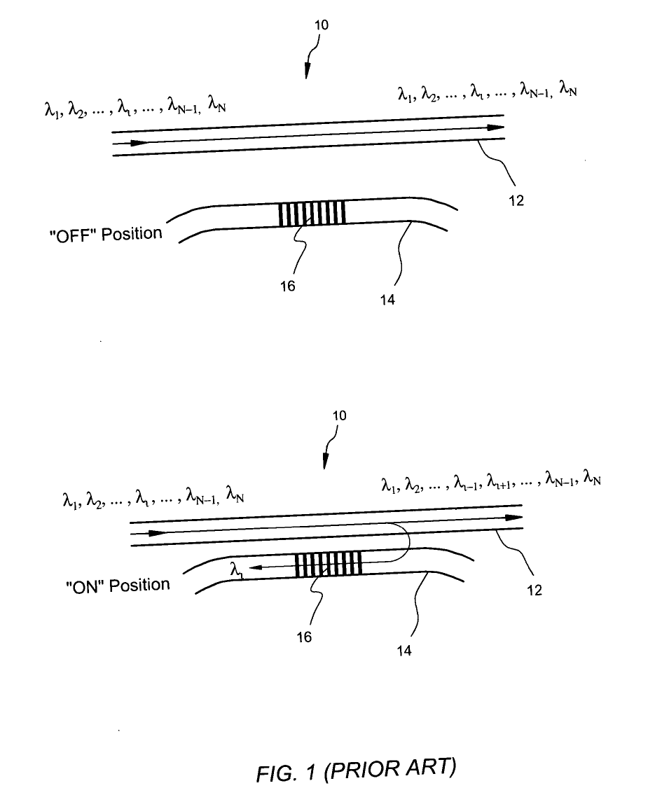

### DETAILED DESCRIPTION OF THE PREFERRED EMBODIMENTS

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

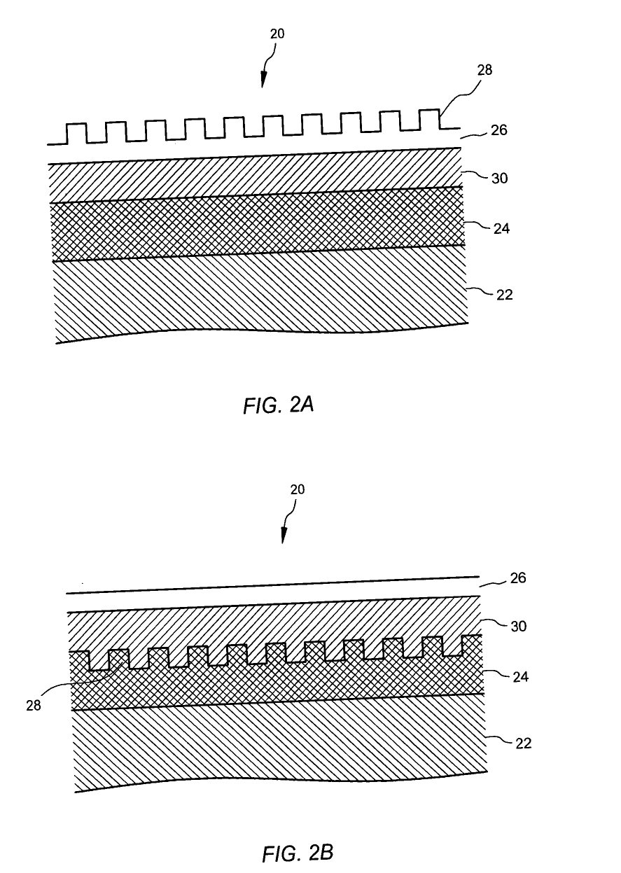

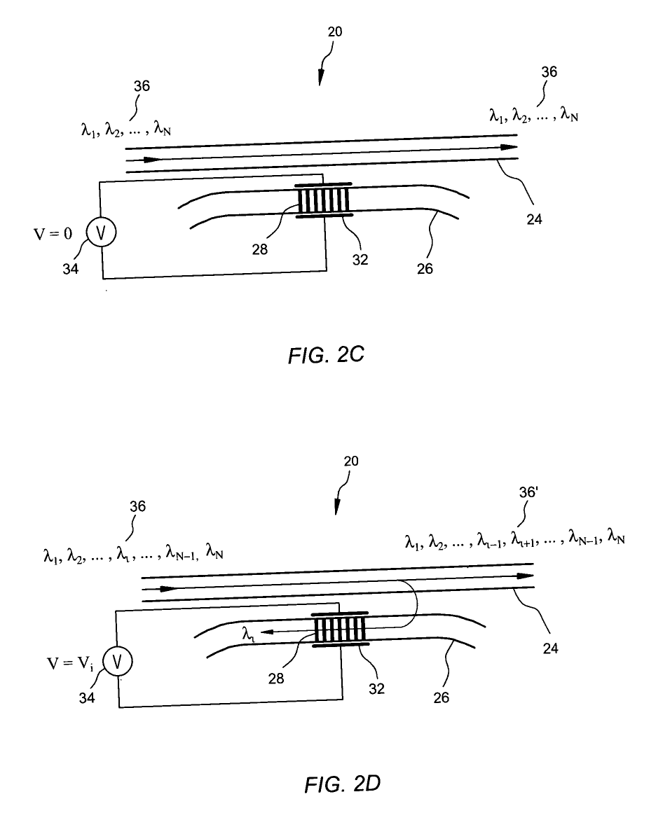

In accordance with one embodiment of the present invention, an electrically activated wavelength-selective optical switch 20 can conveniently be fabricated as a layered structure on a common substrate 22 by using processing techniques known in the art; see FIG. 2A and 2B for two cross-sectional representations of this optical switch 20. This optical switch 20 comprises a first waveguide, e.g., a bus waveguide 24; a second waveguide 26; and a set of Bragg gratings 28. Either or both of the two waveguides comprise an electro optic material. The Bragg gratings 28 may be located next to or integrated with either the second waveguide 26, as shown in FIG. 2A, or the bus waveguide 24, as shown in FIG. 2B. One or more cladding layers 30 may also be present; e.g., between the bus waveguide 24 and the second waveguide 26. The electro-optic material can be selected from a number of materials known in the art, e.g., lanthanum-doped lead zirconate titanate (PLZT) or LiNbO₃, and may have the characteristics of a solid material, a non-poled material, a ceramic material, a polycrystalline material, a non-ferroelectric material, a liquid crystal, a relaxor material, or a combination or blend of the above.

Referring to FIG. 2A, in a specific example of the aforesaid embodiment of the present invention, the substrate 22 is a silicon substrate; the bus waveguide 24 is a doped silicon layer of approximately 5 μm thick; the cladding layer 30 between the bus waveguide 24 and the second waveguide 26 is a silicon dioxide layer with a thickness of not greater than 6 μm; the second waveguide 26 is a PLZT thin film layer of approximately 1 μm thick; and the Bragg gratings 28 are conveniently embodied in a plurality of rod-shaped elements formed by etching the PLZT layer and located in parallel on top of the second waveguide 26 along a direction perpendicular to the light propagation direction of the waveguides 24 and 26. Each of the rod-shaped elements is approximately 500 nm thick and separated from the others with a specific pitch determined by the specific wavelength to be coupled upon the application of an electric field, as described below.

Referring to FIG. 2B, in another specific example of the aforesaid embodiment of the present invention, the substrate 22 is a silicon substrate; the bus waveguide 24 is a doped silicon layer of approximately 5 μm thick; the cladding layer 30 between the bus waveguide 24 and the second waveguide 26 is a silicon dioxide layer with a thickness of up to 6 μm; the second waveguide 26 is a PLZT thin film layer of approximately 1 μm thick. The Bragg gratings 28 are conveniently embodied in a plurality of rod-shaped elements formed by etching the top portion of the doped silicon layer of the bus waveguide 24. These rod-shaped elements are located in parallel along a direction perpendicular to the light propagation direction of the waveguides 24 and 26; each rod-shaped element is approximately 500 nm thick and separated from the others with a specific pitch determined by the specific wavelength to be coupled upon the application of an electric field, as described below.

The optical switch 20 further comprises a means for generating an electrical field across the second waveguide; e.g., two parallel electrodes connected to a voltage source and located either on or off the substrate. FIGS. 2C and 2D are two schematic representations of the optical switch 20 showing the electrodes 32 and the voltage source 34. Note that in FIGS. 2C and 2D the first waveguide 24 and the second waveguide 26 are schematically depicted on the same plane for clarity. In this embodiment, the electrodes are made of platinum and are approximately 5 mm long, 100 nm wide and 2 μm thick; and the voltage source is a TTL source. Note that the electrical field may also be generated across the entire substrate, depending for example on the placement of the electrodes.

The operation of the optical switch 20 in either FIG. 2A or FIG. 2B is schematically depicted in FIGS. 2C and 2D. In the absence of an electrical field (i.e., V=0), multiplexed input optical signals 36 of wavelengths λ₁, λ₂, . . . , λᵢ, . . . , and λ_{N} are transmitted over the bus waveguide 24; see FIG. 2C. When the electrical field is applied across the second waveguide 26 by changing V to a pre-determined value Vᵢ, as shown in FIG. 2D, the refractive index of the electro-optic material of the second waveguide 26 is changed. Accordingly, the Bragg phase-matching condition of the Bragg gratings 28 is altered. As a result, one of the optical signals in the bus waveguide 24 having a center wavelength λᵢ,e.g., 1550.12 nm, now meets the new Bragg phase-matching condition, and will be guided by mode coupling into the second waveguide 26. Thus, the optical signal λᵢ is “switched” from the bus waveguide 24 to the second waveguide 26, with the remaining optical signals 36′ of wavelengths λ₁, λ₂, . . . , λᵢ₋₁, λᵢ₊₁, . . . , and λ_{N} continuing to be transmitted over the bus waveguide 24.

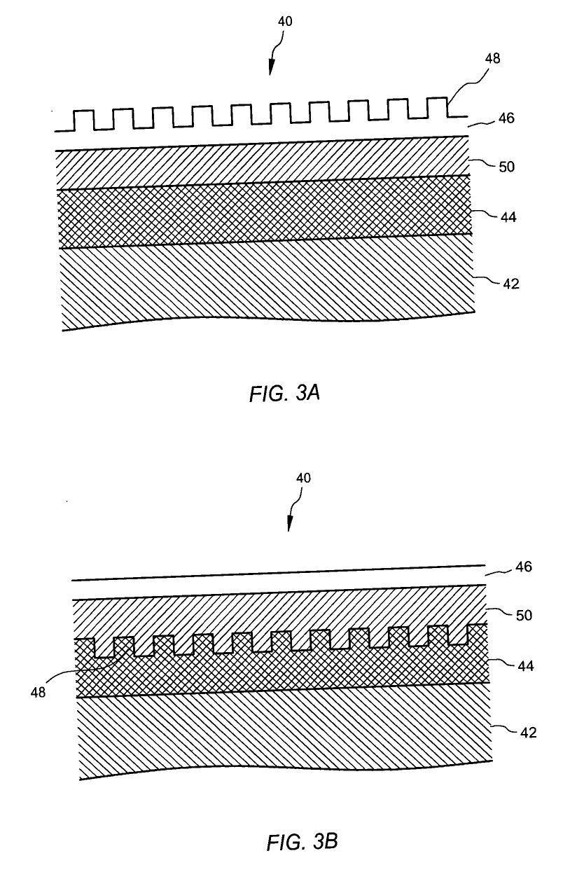

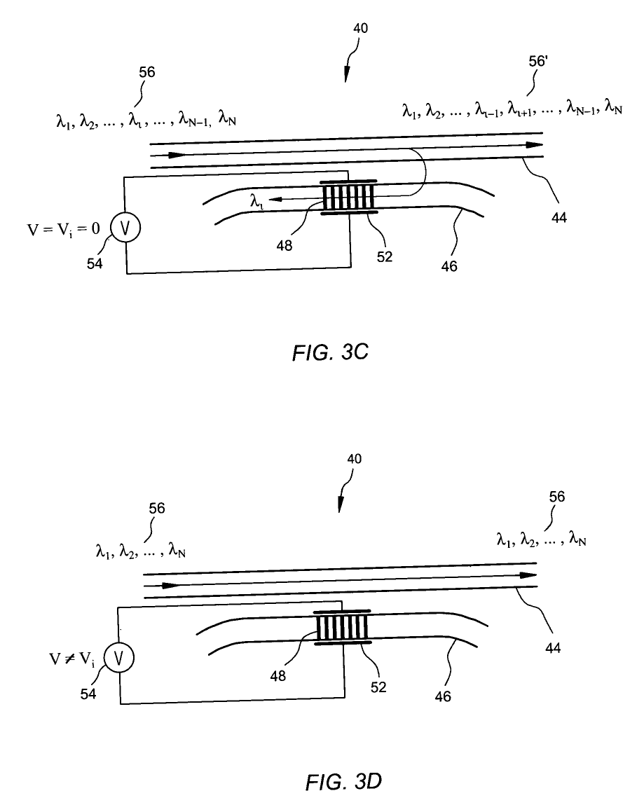

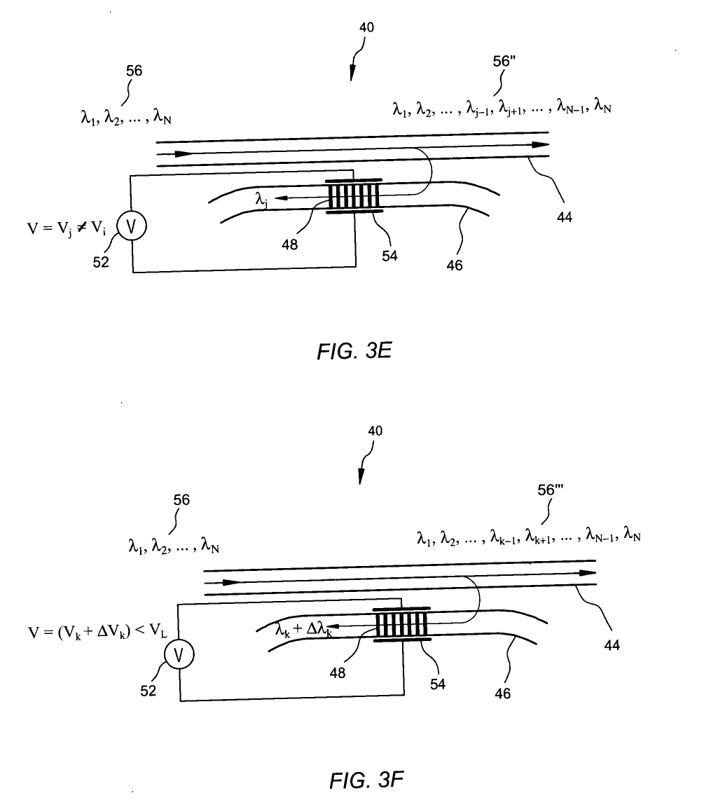

In accordance with another embodiment of the present invention, an electrically activated, wavelength-selective and wavelength-tunable optical switch 40 can conveniently be fabricated as a layered structure on a common substrate 42 by using processing techniques known in the art; see FIGS. 3A and 3B for two cross-sectional representations of this optical switch. This optical switch 40 comprises a first waveguide, e.g., a bus waveguide 44; a second waveguide 46; and a set of Bragg gratings 48. Either or both of the two waveguides comprise an electro optic material. The Bragg gratings 48 may be located next to or integrated with either the second waveguide 46, as shown in FIG. 3A, or the bus waveguide 44, as shown in FIG. 3B. One or more cladding layers 50 may also be present; e.g., between the bus waveguide 44 and the second waveguide 46. The electro-optic material can be selected from a number of materials known in the art, e.g., lanthanum-doped lead zirconate titanate (PLZT) or LiNbO₃, and may have the characteristics of a solid material, a non-poled material, a ceramic material, a polycrystalline material, a non-ferroelectric material, a liquid crystal, a relaxor material, or a combination or blend of the above.

Referring to FIG. 3A, in a specific example of the aforesaid embodiment of the present invention, the substrate 42 is a silicon substrate; the bus waveguide 44 is a doped silicon layer of approximately 5 μm thick; the cladding layer 50 between the bus waveguide 44 and the second waveguide 46 is a silicon dioxide layer with a thickness of not greater than 6 μm; the second waveguide 46 is a PLZT thin film layer of approximately 1 μm thick; and the Bragg gratings 48 are conveniently embodied in a plurality of rod-shaped elements formed by etching the PLZT layer and located in parallel on top of the second waveguide 46 along a direction perpendicular to the light propagation direction of the waveguides 44 and 46. Each of the rod-shaped elements is approximately 500 nm thick and separated from the others with a specific pitch determined by the specific wavelength to be coupled upon the application of an electric field, as described below.

Referring to FIG. 3B, in another specific example of the aforesaid embodiment of the present invention, the substrate 42 is a silicon substrate; the bus waveguide 44 is a doped silicon layer of approximately 5 μm thick; the cladding layer 50 between the bus waveguide 44 and the second waveguide 46 is a silicon dioxide layer with a thickness of not greater than 6 μm; the second waveguide 46 is a PLZT thin film layer of approximately 1 μm thick. The Bragg gratings 48 are conveniently embodied in a plurality of rod-shaped elements formed by etching the top portion of the doped silicon layer of the bus waveguide 44. These rod-shaped elements are located in parallel along a direction perpendicular to the light propagation direction of the waveguides 44 and 46; each rodshaped element is approximately 500 nm thick and separated from the others with a specific pitch determined by the specific wavelength to be coupled upon the application of an electric field, as described below.

The optical switch 40 further comprises a means for generating an electrical field across the second waveguide; e.g., two parallel electrodes connected to a variable voltage source and located either on or off the substrate. FIG. 3C and 3D are two schematic representations of the optical switch 40 showing the electrodes 52 and the voltage source 54. Note that in FIGS. 3C and 3D the first waveguide 44 and the second waveguide 46 are schematically depicted on the same plane for clarity. In the aforesaid specific example of this embodiment, the electrodes are made of platinum and are approximately 5 mm long, 100 nm wide and 2 μm thick; and the variable voltage source can provide a voltage up to approximately 20 V. Note that the electrical field may also be generated across the entire substrate, depending for example on the placement of the electrodes.

The operation of the optical switch 40 in either FIG. 3A or FIG. 3B is schematically depicted in FIGS. 3C through 3F. As shown in FIG. 3C, in the absence of an electrical field (i.e., V=Vᵢ=0), among the multiplexed input optical signals 56 of wavelengths λ₁, λ₂, . . . , λᵢ, . . . , and λ_{N} that are transmitted over the bus waveguide 44, one of the optical signals has a center wavelength λᵢ (e.g., 1550.12 nm) that meets the Bragg phase-matching condition of the Bragg gratings 48, and is guided by mode coupling into the second waveguide 46, while the remaining optical signals 56′ of wavelengths λ₁, λ₂, . . . , λᵢ₋₁, λᵢ₊₁, . . . , and λ_{N} continue to be transmitted over the bus waveguide 44.

When the electrical field is applied across the second waveguide 46 by activating the variable voltage source, the refractive index of the electro-optic material of the second waveguide 46 is changed. Accordingly, the Bragg phase-matching condition of the Bragg gratings 48 is altered, such that the wavelength λᵢ no longer meets the Bragg phase-matching condition. As a result, either of the two following situations will take place: (A), as shown in FIG. 3D, the optical switch 40 is “turned off” by the voltage change (i.e., V≠Vᵢ), and all of the input signals 56 of wavelengths λ₁, λ₂, . . . , λᵢ, . . . , and λ_{N} are now transmitted over the bus waveguide 44; or (B), as shown in FIG. 3E, the optical switch 40 is “tuned” by the voltage change (i.e., V=Vⱼ≠Vᵢ) to another optical signal λⱼ, e.g., 1549.32 nm, which meets the altered Bragg phase-matching condition and, accordingly, is guided by mode coupling into the second waveguide 46, with the remaining optical signals 56″ of wavelengths λ₁, λ₂, . . . , λᵢ, . . . , λⱼ₋₁, λⱼ₊₁, . . . , and λ_{N} being transmitted over the bus waveguide 44.

By slightly changing the magnitude of the electric field, it is possible to “fine-tune” the original wavelength λₖ within a certain channel. For example, as shown in FIG. 3F, by increasing the voltage from Vₖ to Vₖ+ΔVₖ, where ΔVₖ<V_{L}−Vₖ and V_{L} is the voltage for tuning the wavelength λₖ,to its adjacent channel, the optical switch may be “fine-tuned” within a certain channel, e.g., from λₖ to λₖ+Δλₖ.

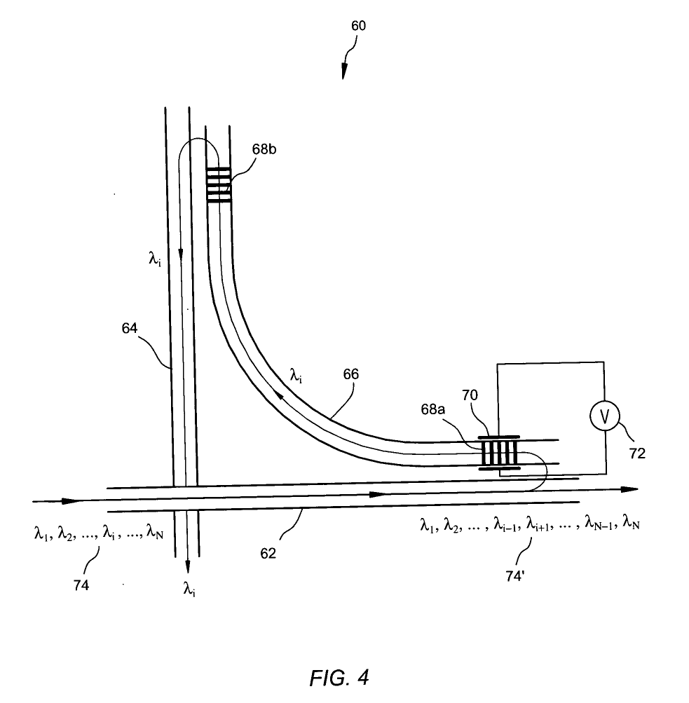

In accordance with still another preferred embodiment, the present invention discloses a wavelength-intelligent optical switch 60, the elements of which can conveniently be either fabricated on a common substrate or functionally assembled or combined, by using processing or assembly techniques known in the art; see FIG. 4. This optical switch 60 comprises a first waveguide 62; a second waveguide 64 intersecting, juxtaposed or crossed over with the first waveguide 62; a third waveguide 66 (i.e., the bridge waveguide) comprising an electro-optic material; and two sets of Bragg grating 68a and 68b disposed on or alongside with the waveguides. Other auxiliary elements, such as cladding layers surrounding each of the waveguides, may also be present.

The electro-optic material of the bridge waveguide 66 can be selected from a number of materials known in the art, e.g., lanthanum-doped lead zirconate titanate (PLZT) or LiNbO₃, and may have the characteristics of a solid material, a non-poled material, a ceramic material, a polycrystalline material, a non-ferroelectric material, a liquid crystal, a relaxor material, or a combination or blend of the above. The Bragg gratings 68a and 68b may conveniently be embodied in a plurality of rod-shaped elements formed by etching the top portion of the bridge waveguide 66 and located in parallel along a direction perpendicular to the light propagation direction. Typically, each of the rod-shaped elements is approximately 500 nm thick and separated from the others with a specific pitch determined by the specific wavelength to be coupled upon the application of an electric field.

The optical switch 60 further comprises a means for generating an electrical field, e.g., two electrodes 70 placed across the first set of Bragg gratings 68a and connected to a voltage source 72. As an example, the electrodes are made of platinum and are 5 mm long and 100 nm wide.

FIG. 4 also depicts schematically the operation of the optical switch 60. In the absence of an electrical field, multiplexed input optical signals 74 of wavelengths λ₁,λ₂, . . . ,λᵢ, . . . , and λ_{N} are transmitted over the first waveguide 62. When the electrical field is applied, the refractive index of the electro-optical material of the bridge waveguide 66 is changed and, accordingly, the Bragg phase-matching condition of the first set of Bragg gratings 68a is altered, causing one of the optical signals having a center wavelength λᵢ (e.g., 1550.12 nm) to be selectively guided into the bridge waveguide 66 via mode coupling. This optical signal of a center wavelength λᵢ travels along the bridge waveguide 66 until it is coupled into the second waveguide 64 by the second set of Bragg gratings 68b, the Bragg phase-matching condition of which is identical to the new Bragg phase-matching condition of the first set of Bragg gratings 68a. As a result, the optical signal λⱼ will be transmitted over the second waveguide 64, while the remaining optical signals 74′ of wavelengths λ₁, λ₂, . . . , λᵢ₋₁, λᵢ₊₁, . . . , and λ_{N} will be transmitted over the first waveguide 62.

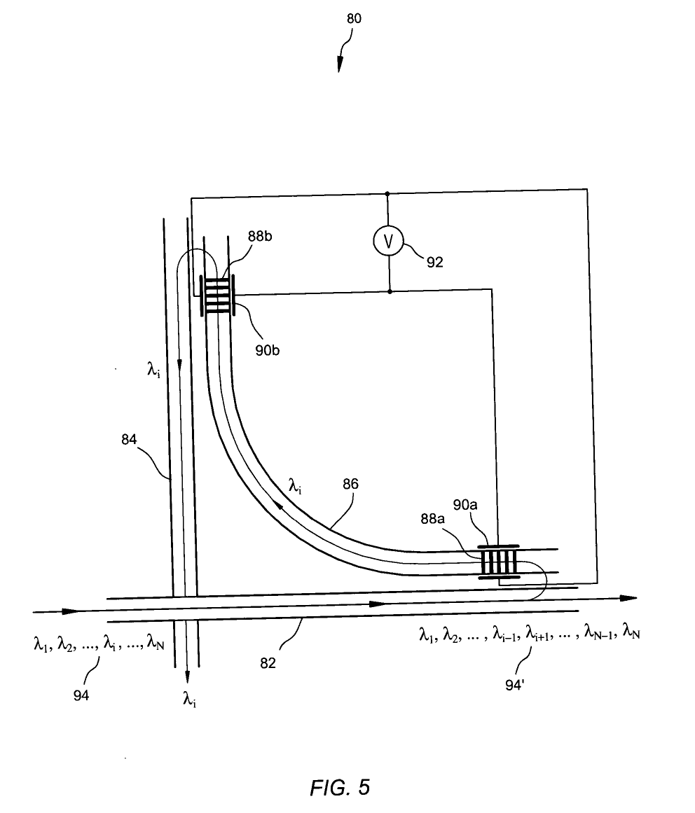

In accordance with yet another preferred embodiment, the present invention discloses a wavelength-tunable optical switch 80, the elements of which can conveniently be either fabricated on a common substrate or assembled or combined functionally, by using processing or assembly techniques known in the art; see FIG. 5. This optical switch 80 comprises a first waveguide 82; a second waveguide 84 intersecting, juxtaposed or crossed over with the first waveguide 82; a third waveguide 86 (i.e., the bridge waveguide) comprising an electro-optic material; and two sets of “variable” Bragg gratings 88a and 88b disposed on or alongside with the waveguides. Other auxiliary elements, such as cladding layers surrounding each of the waveguides, may also be present.

The electro-optic material of the bridge waveguide 86 can be selected from a number of materials known in the art, e.g., lanthanum-doped lead zirconate titanate (PLZT) or LiNbO₃, and may have the characteristics of a solid material, a non-poled material, a ceramic material, a polycrystalline material, a non-ferroelectric material, a liquid crystal, a relaxor material, or a combination or blend of the above. The Bragg gratings 88a and 88b may conveniently be embodied in a plurality of rod-shaped elements formed by etching the top portion of the bridge waveguide 86 and located in parallel along a direction perpendicular to the light propagation direction. Typically, each of the rod-shaped elements is approximately 500 nm thick and separated from the others with a pitch specific to a “base” wavelength, e.g., 1550.12 nm.

To make the Bragg gratings “variable,” the optical switch 80 further comprises means for generating an electrical field, e.g., two electrodes 90a placed across the first set of the Bragg gratings 88a and two electrodes 90b placed across the second set of the Bragg gratings 88b. Each pair of the electrodes is connected to a variable voltage source 92. As an example, the electrodes are made of platinum and are 5 mm long and 100 nm wide.

FIG. 5 also depicts schematically the operation of the optical interconnect 80. In the absence of an electrical field, multiplexed input optical signals 94 of wavelengths λ₁, λ₂, . . . , λᵢ, . . . , and λ_{N} are transmitted over the first waveguide 82. When the electrical field is applied, the refractive index of the electro-optical material of the bridge waveguide 86 is changed and, accordingly, the Bragg phase-matching conditions of both sets of Bragg gratings 88a and 88b are altered, causing one of the optical signals having a center wavelength λᵢ (e.g., 1550.12 nm) to be selectively guided into the bridge waveguide 86 by the first set of Bragg gratings 88a via mode coupling. This optical signal of a center wavelength λᵢ travels along the bridge waveguide 86 until it is coupled into the second waveguide 84 by the second set of Bragg gratings 88b via mode coupling. As a result, the optical signal λᵢ will be transmitted over the second waveguide 84, while the remaining optical signals 94′ of wavelengths λ₁, λ₂, . . . , λᵢ₋₁, λᵢ₊₁, . . . , and λ_{N} will be transmitted over the first waveguide 82.

Referring again to FIG. 5, by varying the voltage and hence the magnitude of the electric field, the optical signal guided into first the bridge waveguide 86 and then the second waveguide 84 can be selectively changed from one to another (e.g., 1549.32 nm), thus making this optical switch wavelength-tunable.

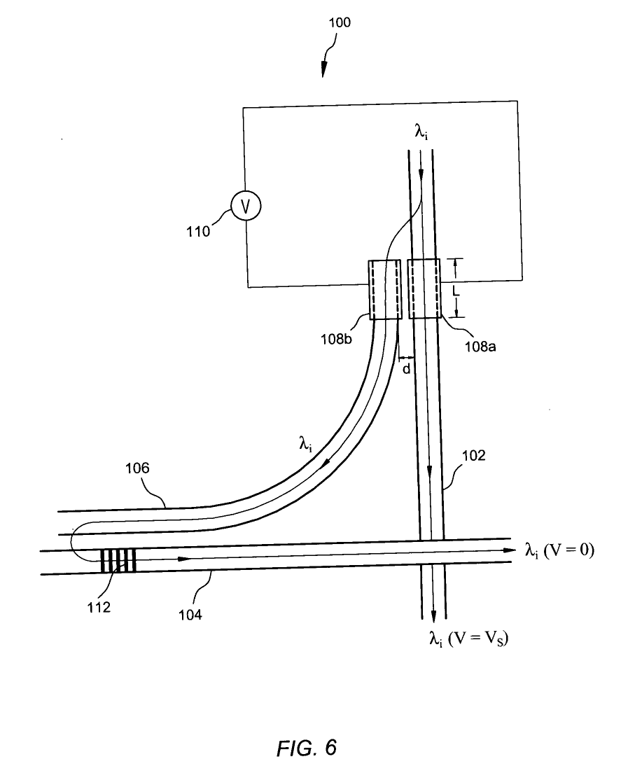

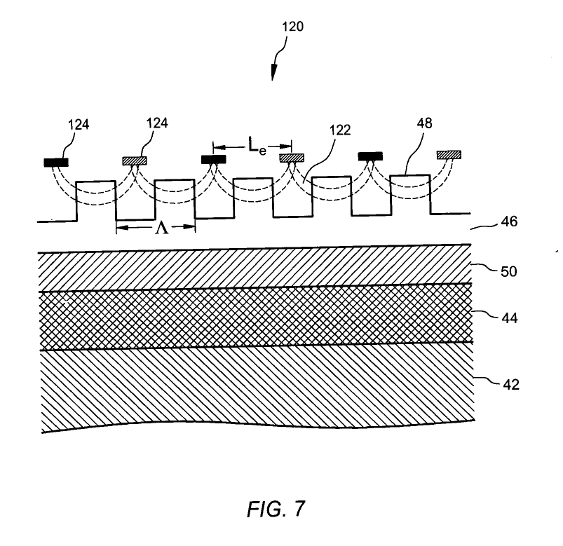

In accordance with another preferred embodiment, the present invention discloses a wavelength-selective optical switch 100, the elements of which can conveniently be either fabricated on a common substrate or assembled as a functional combination, by using processing or assembly techniques known in the art; see FIG. 6. This optical switch 100 comprises a first waveguide 102, at least a section of which (i.e., the coupling section of a length L shown in FIG. 6) comprises an electro-optic material; a second waveguide 104 intersecting, juxtaposed or crossed over with the first waveguide 102; a third waveguide 106 (i.e., the bridge waveguide), at least a section of which comprises the same electro-optic material as that in the first waveguide (i.e., the coupling section of a length L separated from the coupling section of the first waveguide 102 by a distance d, as shown in FIG. 6); a means for generating an electrical field over the two coupling sections, e.g., two electrodes 108a and 108b connected to a voltage source 110; and a set of Bragg gratings 112 disposed on a section of the second waveguide 104 located near the other end of the bridge waveguide 106. This set of Bragg gratings 112 has a Bragg phase-matching condition that corresponds to the input optical signal, as explained below. Other auxiliary elements, such as cladding layers surrounding each of the waveguides, may also be present.

The electro-optic material of the bridge waveguide 106 and the first waveguide 102 can be selected from a number of materials known in the art, e.g., lanthanum-doped lead zirconate titanate (PLZT) or LiNbO₃, and may have the characteristics of a solid material, a non-poled material, a ceramic material, a polycrystalline material, a non-ferroelectric material, a liquid crystal, a relaxor material, or a combination or blend of the above. The Bragg gratings 112 may conveniently be embodied in a plurality of rod-shaped elements formed by etching the top portion of the second waveguide 104 and located in parallel along a direction perpendicular to the light propagation direction. Typically, each of the rod-shaped elements is approximately 500 nm thick and separated from the others with a specific pitch determined by the specific wavelength λᵢ to be coupled from the first waveguide to the bridge waveguide in the absence of the electrical field.

FIG. 6 also depicts schematically the operation of the optical interconnect 100. In the absence of an electrical field (i.e., V=0), the input optical signal of a center wavelength λᵢ is directly coupled over a transmission length L from the first waveguide 102 to the bridge waveguide 106. This optical signal λᵢ is subsequently guided into the second waveguide 104 via mode coupling at the Bragg gratings 112 and will be transmitted over the second waveguide 104. When the electrical field is applied to the two coupling sections of the two waveguides 102 and 106 that comprise the electro-optic material, these two sections will experience an applied field in opposite directions and hence experience opposite changes in their refractive indices, resulting in a phase mismatch between the two waveguides. By adjusting the voltage V and hence the magnitude of the electric field to a certain value (i.e., V=Vₛ), the transmission of light power from the first waveguide to the bridge waveguide can be “switched off.” As a result, the input optical signal λᵢ will continue to be transmitted over the first waveguide 102.

Referring again to the specific embodiment depicted in FIG. 6, the voltage Vₛ required to switch off the transmission of light power of the input optical signal having a center wavelength λᵢ from the first waveguide 102 to the bridge waveguide 106 is given approximated by

Vₛ=3^{1/2}λᵢd/(2n³rL)

Where

λᵢ is the center wavelength of the input optical signal;

d is the distance between the two coupling sections of the first waveguide and the bridge waveguide;

n is the refractive index of the electro-optic material in the absence of the electrical field;

r is the Pockels coefficient of the electro-optic material;

L is the length of the electrodes as well as the length of the coupling sections of the first waveguide and the bridge waveguide.

In several specific embodiments depicted above, the electrical field is generated by applying a voltage to a pair of parallel electrodes placed across a set of Bragg gratings, one or more waveguides, or the entire substrate. FIG. 7 illustrates a specific example in which the means for generating the electrical field is embodied in a different set of electrode configurations.

As shown in the cross-sectional representation of FIG. 7, an electrically activated, wavelength-selective optical switch 120 is fabricated as a layered structure identical to the one shown in FIG. 3A; namely, the optical switch 120 comprises a substrate 42, a first waveguide, e.g., a bus waveguide 44; a second waveguide 46 comprising an electro-optic material; and a set of Bragg gratings 48. One or more cladding layers 50 may also be present, e.g., between the bus waveguide 44 and the second waveguide 46. The Bragg gratings 48 are conveniently embodied in a plurality of rod-shaped elements formed by etching and located in parallel on top of the second waveguide 46 along a direction perpendicular to the light propagation direction of the waveguides 44 and 46.

In the optical switch 120 shown in FIG. 7, the means for generating an electrical field 122 conveniently takes the form of a plurality of strip electrodes 124 placed in parallel to one another and to the rod-shaped elements of the Bragg gratings 48. Typically, these strip electrodes 124 are alternately connected to the positive and negative terminals of one or more voltage sources (not shown). When the voltage source or sources are turned on, the electrical field 122 is generated across the rod-shaped elements of the Bragg gratings 48, resulting in changes of the refractive index of the electro-optic material and of the Bragg phase-matching condition of the Bragg gratings 48.

Preferably, the distance Lₑ between the centerlines of two strip electrodes 124 of FIG. 7 is a multiple of the “period” Λ of the rod-shaped elements of the Bragg gratings 48; i.e., Lₑ=mΛ, where m is an integer.

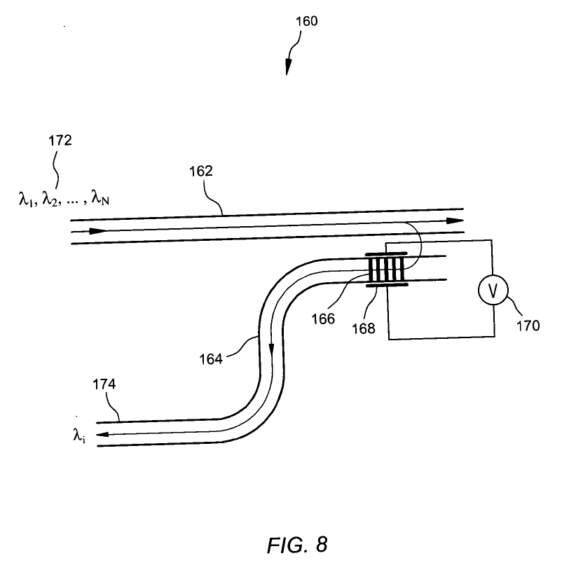

In accordance with still another preferred embodiment, the present invention discloses a tunable wavelength selector (TWS) 160, the elements of which can conveniently be either fabricated on a common substrate or functionally assembled or combined, by using processing or assembly techniques known in the art; see FIG. 8. This tunable wavelength selector 160 comprises a first waveguide, e.g., a bus waveguide 162; a second waveguide, e.g., an output waveguide 164, comprising an electro-optic material; a set of Bragg gratings 166 disposed on the second waveguide 164; and a means for generating an electric field, e.g., two electrodes 168 placed across the Bragg gratings 166 and connected to a voltage source 170.

In the absence of the electric field, the multi-channeled input optical signals 172 of wavelengths λ₁, λ₂, . . . , λᵢ, . . . , and λ_{N} are transmitted over the first waveguide 162. When the electric field is applied by activating the voltage source 170, the refractive index of the electro-optical material of the second waveguide 164 is changed and, accordingly, the Bragg phase-matching condition of the Bragg gratings 166 is altered. If this alteration is of a sufficient magnitude, one of the input optical signals 172 having a center wavelength λᵢ may be selectively guided into the second waveguide 164 via mode coupling. This signal with a selected wavelength is transmitted over the second waveguide 164 to the output port 174 of the second waveguide 164. Depending on the magnitude of the electric field, the optical signal guided into the second waveguide 164 can be selectively switched from one channel (i.e., signal λᵢ) to another channel (i.e., another optical signal having a center wavelength λⱼ) of the input optical signals 172.

In addition to selecting signals of different channels, as explained above, the tunable wavelength selector 160 can also be used to fine-tune the wavelength within a certain channel, e.g., from λᵢ to λᵢ+Δλᵢ, by slightly changing the magnitude of the electric field; e.g., by increasing the voltage from Vᵢ to Vᵢ+ΔVᵢ, where ΔVᵢ<Vⱼ−Vᵢ and Vⱼ is the voltage for tuning the wavelength from one channel λᵢ to the next channel λⱼ.

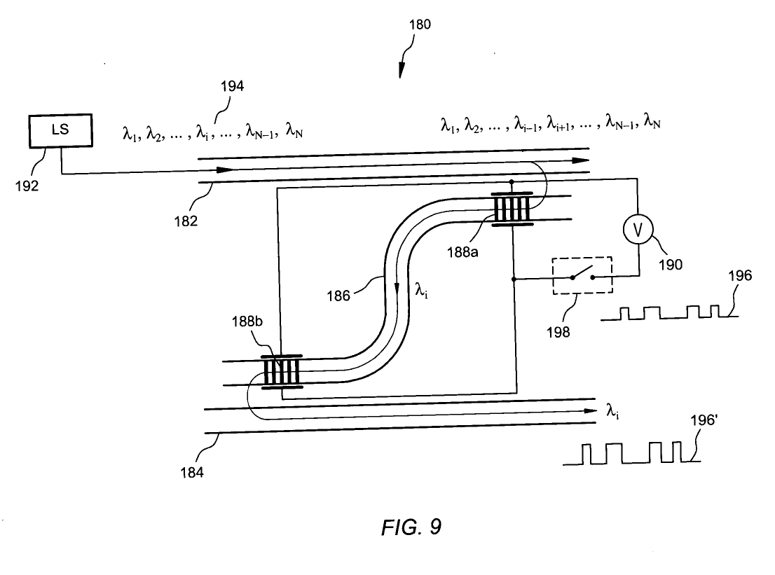

In accordance with yet another preferred embodiment, the present invention discloses a wavelength-tunable light modulator (WTLM), the elements of which can conveniently be either fabricated on a common substrate or functionally assembled or combined, by using processing or assembly techniques known in the art; see FIG. 9. This wavelength-tunable light modulator 180 comprises a first waveguide 182 (i.e., the bus waveguide); a second waveguide 184 in parallel to, intersecting or crossed over with the first waveguide 182 (i.e., the output waveguide); a third waveguide 186 (i.e., the bridge waveguide) comprising an electro-optical material; two identical sets of Bragg gratings 188a and 188b disposed at the two ends of the bridge waveguide 186; a means for generating an electrical field at each set of Bragg gratings, e.g., two electrodes placed across each of the two sets of the Bragg gratings 188a and 188b and connected to a voltage source 190; and a broadband light source 192.

In the absence of an electric field, all of the multiplexed input optical signals 194 of wavelengths λ₁, λ₂, . . . , λᵢ, . . . , and λ_{N} from the broadband light source 192 are transmitted over the first waveguide 182. When an electric field is applied, the refractive index of the electro-optical material of the bridge waveguide 186 is changed and, accordingly, the Bragg phase-matching conditions of the two sets of Bragg gratings are altered, causing one of the optical signals having a center wavelength λᵢ to be selectively guided into the bridge waveguide 186 at the first set of Bragg gratings 188a via mode coupling. Through the bridge waveguide 186 and the second set of Bragg gratings 188b located close to the output waveguide 184, the selected optical signal is further “filtered” and coupled to the output waveguide 184. Depending on the magnitude of the electrical field, the optical signal guided into the bridge waveguide 186 can be selectively switched from one wavelength λᵢ to another wavelength λⱼ, thus making this device wavelength-tunable.

In the wavelength-tunable light modulator 180 shown in FIG. 9, the electrical field can be turned on or off by using a predetermined digital signal input (i.e., an information-bearing signal 196) to control the on/off switch 198 of the voltage source 190. Thus, the information-bearing signal 196 is in effect imposed on the optical output signal of the selected wavelength λᵢ, resulting in a modulated optical output signal 196′.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A wavelength-selective optical switch comprising:
a first waveguide and a second waveguide;
at least one of said first and second waveguides comprising an electro-optic material having a set of Bragg gratings disposed therein for interfacing between said first and second waveguides; and
means for generating an electrical field across said electro-optical material for changing an electro-optical characteristic of said electro-optic material for effecting an optical switching function corresponding to said electrical field.

2. The wavelength-selective optical switch of claim 1 wherein:
said means for generating an electrical field is provided for turning on and off a transmission of an optical signal from said first waveguide to said second waveguide.

3. The wavelength-selective optical switch of claim 1 wherein:
said means for generating an electrical field is provided for turning on and off a transmission of an optical signal of a selective wavelength from said first waveguide to said second waveguide.

4. The wavelength-selective optical switch of claim 1 wherein:
said means for generating an electrical field is provided for turning on and off a transmission of an optical signal of a tunable wavelength by changing said electrical field from said first waveguide to said second waveguide.

5. The wavelength-selective optical switch of claim 1 wherein:
said first waveguide intersecting said second waveguide and set of Bragg gratings disposed near an intersection between said first and second waveguides.

6. The wavelength-selective optical switch of claim 1 wherein:
said electro-optical material comprising a lanthanum-doped lead zirconate titanate (PLZT).

7. The wavelength-selective optical switch of claim 1 wherein:
said electro-optical material comprising a LiNbO₃.

8. The wavelength-selective optical switch of claim 1 wherein:
said electro-optical material comprising a solid material having a tunable electro-optical characteristic.

9. The wavelength-selective optical switch of claim 1 wherein:
said electro-optical material comprising a non-poled material having a tunable electro-optical characteristic.

10. The wavelength-selective optical switch of claim 1 wherein:
said electro-optical material comprising a ceramic material having a tunable electro-optical characteristic.

11. The wavelength-selective optical switch of claim 1 wherein:
said electro-optical material comprising a polycrystalline material having a tunable electro-optical characteristic.

12. The wavelength-selective optical switch of claim 1 wherein:
said electro-optical material comprising a non-ferroelectric material having a tunable electro-optical characteristic.

13. The wavelength-selective optical switch of claim 1 wherein:
said electro-optical material comprising a liquid crystal material having a tunable electro-optical characteristic.

14. The wavelength-selective optical switch of claim 1 wherein:
said electro-optical material comprising a relaxor material having a tunable electro-optical characteristic.

15. The wavelength-selective optical switch of claim 1 wherein:
said means for generating an electrical field across said electro-optical material for changing an refraction index of said electro-optic material for effecting an optical switching function corresponding to said electrical field.

16. A wavelength-selective optical device comprising:
a set of Bragg gratings formed with an electro-optic material for electrically tuning and selecting a wavelength to transmit through said set of Bragg gratings.

17. The wavelength-selective optical device of claim 16 further comprising:
a means for applying an electric field over said set of electro-optic material for tuning and selecting a wavelength.

18. The wavelength-selective optical device of claim 16 wherein:
said electro optic material disposed in a waveguide.

19. The wavelength-selective optical device of claim 16 wherein:
said electro optic material disposed in a waveguide coupled to and controlling a signal transmission from an input waveguide to an output waveguide.

20. A method for configuring a wavelength-selective optical device comprising:
electrically tuning and selecting a wavelength to transmit through a set of Bragg gratings formed with an electro-optic material.

21. The method of claim 20 further comprising a step of:
applying an electric field over said set of Bragg gratings for tuning and selecting a wavelength.

22. The method of claim 21 further comprising a step of:
forming said set of Bragg gratings in a waveguide comprising said electro optic material.

23. The method of claim 20 further comprising a step of:
forming said set of Bragg gratings in a waveguide comprising said electro optic material and coupling said waveguide to an input waveguide to an output waveguide for controlling a signal transmission.

24. A wavelength-selective optical switch comprising:
a first waveguide and a second waveguide;
at least one of said first and second waveguides comprising an electro-optic material having a set of Bragg gratings disposed therein for interfacing and wavelength-selecting an optical signal transmission between said first and second waveguides.

25. The wavelength-selective optical switch of claim 24 wherein:
one of said first and second waveguides comprising an silicon oxide waveguide.

26. The wavelength-selective optical switch of claim 24 further comprising:
means for generating a variable electrical field across said electro-optical material for changing and tuning an electro-optical characteristic of said Bragg gratings for effecting an optical switching and wavelength tuning function corresponding to said variable electrical field.

27. The wavelength-selective optical switch of claim 24 wherein:
said electro-optical material comprising a lanthanum-doped lead zirconate titanate (PLZT).

28. The wavelength-selective optical switch of claim 24 further comprising:
said first intersecting said second waveguide with said set of Bragg gratings disposed near an intersection between said first and second waveguide.

29. The wavelength-selective optical switch of claim 24 further comprising:
a substrate for supporting one of said first and second waveguides; and
means for generating an electrical field in parallel to a planar direction of said substrate across said electro-optical material for changing an electro-optical characteristic of said Bragg gratings for effecting a change of an optical signal transmission corresponding to said electrical field.

30. The wavelength-selective optical switch of claim 24 further comprising:
a substrate for supporting one of said first and second waveguides; and
means for generating an electrical field along a non-parallel direction relative to a planar direction of said substrate wherein said electrical field is applied across said electro-optical material for changing an electro-optical characteristic of said Bragg gratings for effecting a change of an optical signal transmission corresponding to said electrical field.

31. The wavelength-selective optical switch of claim 24 further comprising:
a substrate for supporting one of said first and second waveguides; and
means for generating an electrical field along a perpendicular direction relative to a planar direction of said substrate wherein said electrical field is applied across said electro-optical material for changing an electro-optical characteristic of said Bragg gratings for effecting a change of an optical signal transmission corresponding to said electrical field.

32. The wavelength-selective optical switch of claim 24 further comprising:
a substrate for supporting one of said first and second waveguides; and
said first intersecting said second waveguide with said set of Bragg gratings disposed near an intersection between said first and second waveguide wherein said first waveguide disposed vertically above said second waveguide along a direction perpendicular to a planar direction of said substrate.
